(19) United States
(12) Patent Application Publication
(10) Pub. No.: US 2026/0229740 A1
(43) Pub. Date: Aug. 6, 2026

(54) FUSE UNIT AND CONDUCTIVE MODULE

(71) Applicant: YAZAKI CORPORATION, Tokyo (JP)

(72) Inventors: Katsunori Sato, Makinohara-shi (JP); Mariko Nakagawa, Makinohara-shi (JP); Yasuhiro Kominato, Makinohara-shi (JP); Miho Suzuki, Makinohara-shi (JP); Kota Morishige, Makinohara-shi (JP)

(21) Appl. No.: 19/530,363

(22) Filed: Feb. 5, 2026

(30) Foreign Application Priority Data
Feb. 6, 2025 (JP) 2025-018132

(51) Int. Cl. H01M 50/583; H01H 85/02; H01H 85/055; H01H 85/143; H01M 50/502; H01M 50/569

(52) U.S. Cl. CPC H01M 50/583; H01H 85/0241; H01H 85/055; H01H 85/143; H01M 50/502; H01M 50/569; H01M 2200/00

(57) ABSTRACT

A fuse unit includes a fuse having a first electrode, a second electrode, and a fusible portion between the first electrode and the second electrode, a first conductive member connected to the first electrode, and a second conductive member connected to the second electrode, wherein the first conductive member extends from the first electrode in a first extending direction, and wherein the second conductive member extends from the second electrode in a second extending direction orthogonal to the first extending direction.

### CROSS-REFERENCE TO RELATED APPLICATION(S)

The present application claims priority to and incorporates by reference the entire contents of Japanese Patent Application No. 2025-018132 filed in Japan on Feb. 6, 2025.

### BACKGROUND OF THE INVENTION

### 1. Field of the Invention

The present invention relates to a fuse unit and a conductive module.

### 2. Description of the Related Art

In the related art, there is a fuse unit. JP 7 561 318 B2 discloses a fuse unit including a first terminal electrically connected to a mating member, a second terminal electrically connected directly or indirectly to a wiring member, a resin portion covering a part of the first terminal and a part of the second terminal, and a chip fuse.

Here, a requirement for an arrangement of the fuse unit may vary depending on an object to which the fuse unit is applied. Therefore, it is desirable to have a high degree of freedom in design when the fuse unit is disposed with respect to the object.

### SUMMARY OF THE INVENTION

An object of the present invention is to provide a fuse unit and a conductive module capable of improving a degree of freedom in design when the fuse unit is disposed with respect to an object.

In order to achieve the above mentioned object, a fuse unit according to one aspect of the present invention includes a fuse having a first electrode, a second electrode, and a fusible portion between the first electrode and the second electrode; a first conductive member connected to the first electrode; and a second conductive member connected to the second electrode, wherein the first conductive member extends from the first electrode in a first extending direction, and wherein the second conductive member extends from the second electrode in a second extending direction orthogonal to the first extending direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a conductive module according to an embodiment;

FIG. 2 is a plan view of a fuse unit according to the embodiment;

FIG. 3 is a plan view of the fuse unit according to the embodiment;

FIG. 4 is a plan view of the conductive module according to the embodiment; and

FIG. 5 is a plan view of the conductive module according to the embodiment.

### DETAILED DESCRIPTION OF THE PREFERRED EMBODIMENTS

Hereinafter, a fuse unit and a conductive module according to an embodiment of the present invention will be described in detail with reference to the drawings. The present invention is not limited by the embodiment. In addition, constituent elements in the following embodiment include those that can be easily assumed by those skilled in the art or those that are substantially the same as actual ones.

### Embodiment

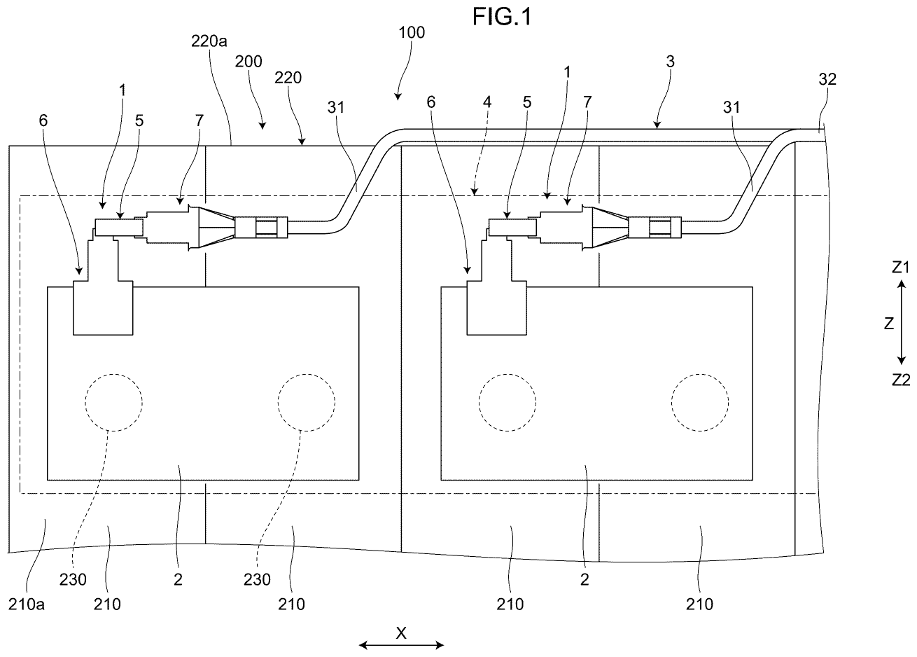

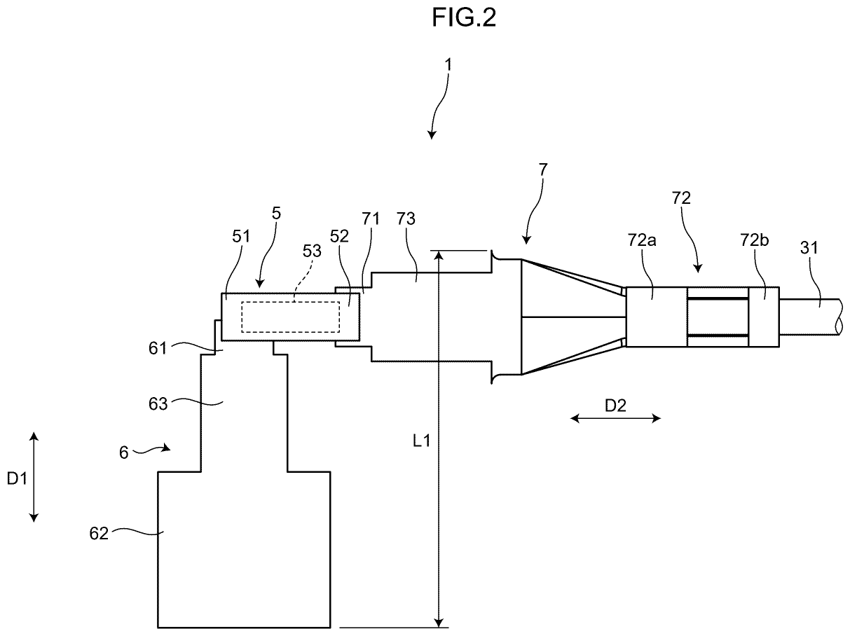

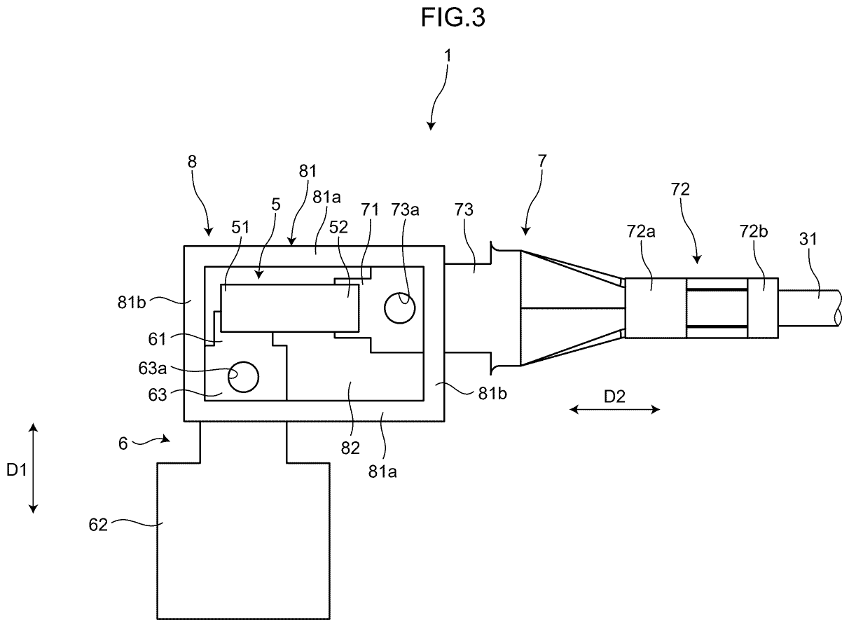

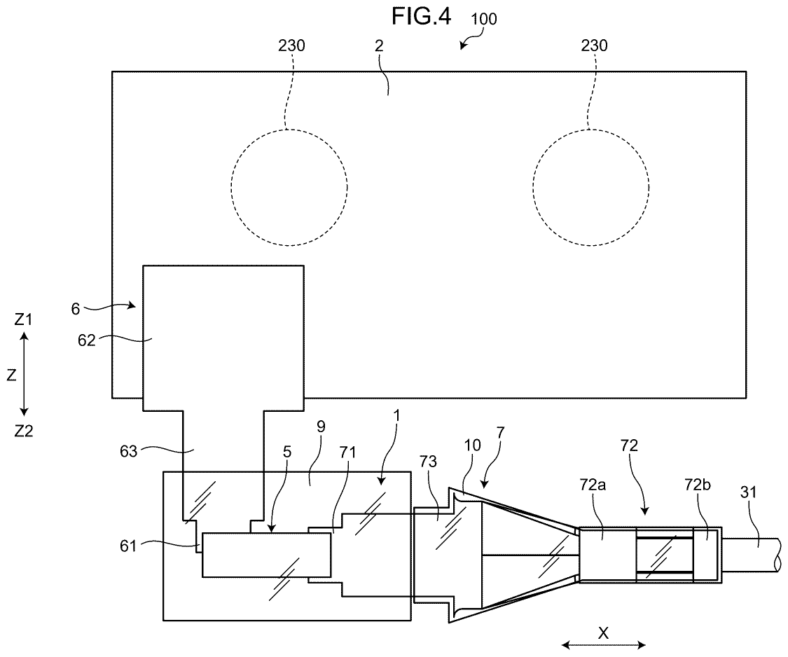

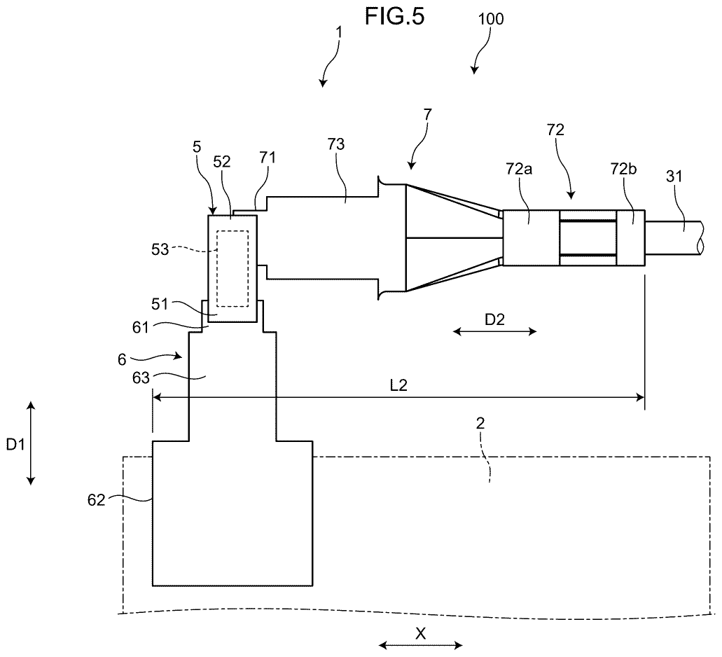

An embodiment will be described with reference to FIGS. 1 to 5. The present embodiment relates to a fuse unit and a conductive module. FIG. 1 is a plan view of the conductive module according to the embodiment, FIGS. 2 and 3 are plan views of the fuse unit according to the embodiment, and FIGS. 4 and 5 are plan views of the conductive module according to the embodiment.

As illustrated in FIG. 1, a conductive module 100 of the present embodiment is a bus bar module having a fuse unit 1, a bus bar 2, and a routing member 3. The conductive module 100 may have a case 4 that holds the fuse unit 1 and the bus bar 2. The case 4 may be configured to be able to accommodate the routing member 3.

The conductive module 100 is disposed in a battery pack 200, for example. The battery pack 200 is mounted as a power source on a vehicle such as an automobile. The battery pack 200 has a battery module 220. The battery module 220 has a plurality of battery cells 210 arranged in a first direction X. The conductive module 100 of FIG. 1 is assembled to the battery module 220.

The bus bar 2 is formed of a conductive metal plate. The bus bar 2 electrically connects two adjacent battery cells 210. More specifically, the bus bar 2 is fixed to an electrode 230 of one battery cell 210 and an electrode 230 of the other battery cell 210, and electrically connects the two electrodes 230. In the battery module 220 illustrated in FIG. 1, the electrode 230 is disposed on a side surface 210a of battery cell 210. The conductive module 100 of the present embodiment has a plurality of bus bars 2 arranged in the first direction X and a plurality of fuse units 1 corresponding to the plurality of bus bars 2.

The routing member 3 has a plurality of detection lines 31 and is routed in the first direction X. The illustrated routing member 3 is a flat routing member. The routing member 3 is, for example, a flexible flat cable including a plurality of electric wires and a sheath covering the plurality of electric wires. Each electric wire of the routing member 3 is connected to the corresponding bus bar 2 and functions as the detection line 31. A connector is disposed at an end portion of the routing member 3. Each detection line 31 is connected to a terminal of the connector. The detection line 31 is connected to, for example, a monitoring device that monitors the battery pack 200. In this case, the monitoring device acquires a voltage of the battery cell 210 via the detection line 31, and monitors a state of the battery module 220.

In the illustrated battery cell 210, the electrode 230 is disposed on the side surface 210a in a third direction Z. The third direction Z is, for example, a vehicle vertical direction. The bus bar 2 is disposed on the side surface 210a of the battery cell 210 and is connected to the electrode 230. The fuse unit 1 is disposed on the side surface 210a of the battery cell 210 and is interposed between the bus bar 2 and the detection line 31. The routing member 3 has a trunk line 32 routed to the battery module 220 in the first direction X. The trunk line 32 is disposed, for example, on a top surface 220a of the battery module 220. The top surface 220a is a surface facing a first side Z1 in the third direction Z. The first side Z1 is typically an upper side in the vehicle vertical direction.

The fuse unit 1 has a fuse 5, a first conductive member 6, and a second conductive member 7. The fuse 5 is a circuit protection component that cuts off a circuit when an overcurrent flows. The fuse 5 of the present embodiment is a chip fuse. As illustrated in FIG. 2, the fuse 5 has a first electrode 51, a second electrode 52, and a fusible portion 53.

The first electrode 51 is connected to one end portion of the fusible portion 53. The second electrode 52 is connected to the other end portion of the fusible portion 53. The fusible portion 53 is configured to cut off a portion between the first electrode 51 and the second electrode 52 by fusing when an overcurrent flows. The fusible portion 53 is, for example, a fuse element having predetermined fusing characteristics.

The first conductive member 6 and the second conductive member 7 are members having conductivity, and are formed of, for example, metal plates. The first conductive member 6 is connected to the first electrode 51 of the fuse 5. The second conductive member 7 is connected to the second electrode 52 of the fuse 5. That is, the fuse 5 is a protective component interposed between the first conductive member 6 and the second conductive member 7.

The first conductive member 6 has a first connecting portion 61, a second connecting portion 62, and an intermediate portion 63. The illustrated first conductive member 6 is a flat plate-like member having a linear shape in a plan view. The first connecting portion 61 is an end portion on one side of the first conductive member 6, and the second connecting portion 62 is an end portion on the other side. The first connecting portion 61 is formed so as to be joinable to the first electrode 51 of the fuse 5. The first connecting portion 61 has a rectangular flat plate shape and has a width slightly greater than that of the first electrode 51. The first connecting portion 61 is joined to the first electrode 51 by, for example, solder or the like.

The second connecting portion 62 is formed so as to be joinable to the bus bar 2. The second connecting portion 62 has a rectangular flat plate shape and has a width greater than that of the first connecting portion 61. The intermediate portion 63 is a portion between the first connecting portion 61 and the second connecting portion 62. The shape of the intermediate portion 63 in a plan view is rectangular. The width of the intermediate portion 63 is greater than the width of the first connecting portion 61 and smaller than the width of the second connecting portion 62.

The second conductive member 7 has a first connecting portion 71, a second connecting portion 72, and an intermediate portion 73. The illustrated second conductive member 7 is a crimp terminal having a linear shape in a plan view. The first connecting portion 71 is an end portion on one side of the second conductive member 7, and the second connecting portion 72 is an end portion on the other side. The first connecting portion 71 is formed so as to be joinable to the second electrode 52 of the fuse 5. The first connecting portion 71 has a rectangular flat plate shape and has a width slightly greater than that of the second electrode 52. The first connecting portion 71 is joined to the second electrode 52 by means of, for example, solder or the like.

The illustrated second connecting portion 72 is a crimp portion crimped to the detection line 31. The second connecting portion 72 has a core wire crimp portion 72a and a sheath crimp portion 72b. The core wire crimp portion 72a is crimped to a core wire of the detection line 31 and holds the core wire. The sheath crimp portion 72b is crimped to an insulation sheath of the detection line 31 to hold the sheath. The shapes of the crimp portions 72a and 72b after being crimped are, for example, cylindrical shapes.

The intermediate portion 73 is a portion between the first connecting portion 71 and the second connecting portion 72. The shape of the intermediate portion 73 in a plan view is rectangular. The width of the intermediate portion 73 is greater than the width of the first connecting portion 71.

In the fuse unit 1 of the present embodiment, the first conductive member 6 connected to the fuse 5 extends from the first electrode 51 in a first extending direction D1. Also, the second conductive member 7 connected to the fuse 5 extends from the second electrode 52 in a second extending direction D2. The second extending direction D2 is orthogonal to the first extending direction D1. That is, the fuse 5, the first conductive member 6, and the second conductive member 7 have a substantially L shape in a plan view.

In the fuse unit 1 of FIG. 2, the fuse 5 and the second conductive member 7 are linearly arranged in the second extending direction D2. In other words, the second conductive member 7 extends in an arrangement direction of the first electrode 51 and the second electrode 52. The first conductive member 6 extends in a direction orthogonal to the fuse 5 and the second conductive member 7.

By arranging the first conductive member 6 and the second conductive member 7 so as to be orthogonal to each other as described above, the degree of freedom in arrangement and design of the fuse unit 1 is improved. For example, in the fuse unit 1 of FIG. 2, a first dimension L1 can be minimized. The first dimension L1 is a maximum dimension of the fuse unit 1 in the first extending direction D1.

In the conductive module 100 illustrated in FIG. 1, the fuse unit 1 is disposed on the first side Z1 in the third direction Z with respect to the electrode 230. That is, the fuse unit 1 is disposed above the electrode 230. When the position of the electrode 230 in the battery cell 210 is desired to be located as high as possible, an arrangement space of the fuse unit 1 in the third direction Z is desirably small. In the fuse unit 1 illustrated in FIG. 2, the first dimension L1 can be reduced. Accordingly, the arrangement space of the fuse unit 1 in the third direction Z is reduced. As a result, for example, the case 4 can be downsized in the third direction Z.

In the fuse unit 1 illustrated in FIG. 2, the detection line 31 is drawn out from the second conductive member 7 in the first direction X. That is, the detection line 31 is drawn out in an extending direction of the trunk line 32. As a result, an excessive bending portion is less likely to occur in the detection line 31.

The fuse unit 1 of FIG. 1 is disposed such that the fuse 5 and the second conductive member 7 are located on the first side Z1 in the third direction Z with respect to the bus bar 2. Therefore, even if liquid leakage occurs from the electrode 230, the leaked liquid is less likely to adhere to the fuse 5 and the second conductive member 7. The detection line 31 extends from the second conductive member 7 toward the first side Z1. In other words, the detection line 31 does not hang down with respect to the second conductive member 7. As a result, even if liquid leakage occurs from the electrode 230, the routing member 3 is less likely to be affected by the leaked liquid.

The first conductive member 6 in FIG. 1 is joined to an end portion of the bus bar 2 on the first side Z1. The first conductive member 6 is joined to the bus bar 2 such that, for example, the first conductive member 6 is located on the first side Z1 with respect to the electrode 230. In this case, the entire fuse unit 1 is disposed above the electrode 230 in the vehicle vertical direction. Therefore, even if liquid leakage occurs from the electrode 230, the leaked liquid is less likely to reach the fuse unit 1 and the routing member 3.

The first conductive member 6 in FIG. 1 protrudes from the bus bar 2 toward the first side Z1. Therefore, the fuse 5 and the second conductive member 7 are separated from the bus bar 2 in the third direction Z. Therefore, even if liquid leakage occurs from the electrode 230, the leaked liquid cannot easily reach the fuse 5 and the second conductive member 7.

When the fuse unit 1 of FIG. 2 is assembled to the battery module 220, the arrangement of the fuse unit 1 is not limited to the arrangement of FIG. 1. For example, in a plan view of the bus bar 2, the first conductive member 6 may overlap the electrode 230. Even in this case, the fuse 5 and the second conductive member 7 are desirably located on the first side Z1 with respect to the electrode 230.

As illustrated in FIG. 3, the fuse unit 1 may include a holding member 8 that holds the first conductive member 6 and the second conductive member 7. The holding member 8 is formed of, for example, an insulating synthetic resin. The holding member 8 may be integrally formed with the two conductive members 6 and 7. The holding member 8 is formed so as to expose the two connecting portions 61 and 62 of the first conductive member 6 and the two connecting portions 71 and 72 of the second conductive member 7. The fuse 5 may be connected to the conductive members 6 and 7 after the holding member 8 is formed, or may be connected to the conductive members 6 and 7 before the holding member 8 is formed.

The holding member 8 has a frame-shaped side wall 81 and a bottom wall 82. The illustrated shape of the bottom wall 82 is a rectangular plate shape. The side wall 81 is erected from the bottom wall 82. The side wall 81 has a pair of first wall portions 81a and a pair of second wall portions 81b. The pair of first wall portions 81a face each other in the first extending direction D1. The pair of second wall portions 81b face each other in the second extending direction D2. The fuse 5 is accommodated in an accommodation space formed by the bottom wall 82 and the side wall 81.

The holding member 8 preferably accommodates the fuse 5 and the two first connecting portions 61 and 71 in the accommodation space. In this case, even if liquid leakage occurs from the electrode 230, the side wall 81 and the bottom wall 82 of the holding member 8 can protect the fuse 5 and the two first connecting portions 61 and 71 against the leaked liquid.

When the fuse unit 1 has the holding member 8, the conductive members 6 and 7 may be provided with through holes 63a and 73a. The through hole 63a is formed in the intermediate portion 63 of the first conductive member 6, and the through hole 73a is formed in the intermediate portion 73 of the second conductive member 7. The resin forming the holding member 8 fills the through holes 63a and 73a and locks the conductive members 6 and 7.

The holding member 8 may be filled with a potting agent for protecting the fuse 5. The potting agent fills the space formed by the bottom wall 82 and the side wall 81 and covers the fuse 5 and the two first connecting portions 61 and 71. The fuse unit 1 may have a protective layer 10 that covers a joint portion between the second conductive member 7 and the detection line 31. For example, as illustrated in FIG. 4, the protective layer 10 is formed so as to cover the second connecting portion 72 and the intermediate portion 73 of the second conductive member 7. The protective layer 10 is formed of, for example, an insulating synthetic resin. The resin forming the protective layer 10 may be a resin that is cured by ultraviolet rays or the like.

As illustrated in FIG. 4, the fuse unit 1 may be disposed on a second side Z2 in the third direction Z with respect to the electrode 230. The second side Z2 is typically a lower side in the vehicle vertical direction. The second connecting portion 62 of the first conductive member 6 is joined to the bus bar 2 at a position on the second side Z2 with respect to the electrode 230, for example. In this case, the fuse 5 is positioned on the second side Z2 with respect to the electrode 230.

The fuse unit 1 may have a resin protective body 9 covering at least the fuse 5. The protective body 9 is formed to seal the fuse 5. The protective body 9 may be formed so as to integrally cover the entire fuse 5, the first connecting portion 61 of the first conductive member 6, and the first connecting portion 71 of the second conductive member 7. The fuse unit 1 may have the resin protective layer 10 that covers the second connecting portion 72 of the second conductive member 7. The protective layer 10 may cover the intermediate portion 73. The protective body 9 and the protective layer 10 can protect a circuit including the fuse 5 against a liquid such as an electrolytic solution.

The fuse unit 1 of FIG. 4 may have a holding member 8 similar to the holding member 8 of FIG. 3. In this case, the protective body 9 may be formed by filling the holding member 8. The protective body 9 filled in the holding member 8 may be a potting agent.

FIG. 5 illustrates another fuse unit 1 and conductive module 100 according to the embodiment. The fuse unit 1 of FIG. 5 is different from the fuse unit 1 of FIG. 2 in that, for example, the first conductive member 6 is linearly arranged with respect to the fuse 5.

In the fuse unit 1 of FIG. 5, the fuse 5 and the first conductive member 6 are linearly arranged in the first extending direction D1. In other words, the first conductive member 6 extends in an arrangement direction of the first electrode 51 and the second electrode 52. The second conductive member 7 extends in a direction orthogonal to the fuse 5 and the first conductive member 6.

In the fuse unit 1 of FIG. 5, a second dimension L2 can be minimized. The second dimension L2 is a maximum dimension of the fuse unit 1 in the second extending direction D2. When the thickness of the battery cell 210 is desired to be reduced, an arrangement space of the fuse unit 1 in the first direction X is desirably small. In the fuse unit 1 illustrated in FIG. 5, the second dimension L2 can be reduced. As a result, it is possible to cope with a reduction in thickness of the battery cell 210 without interfering with the two adjacent fuse units 1.

For example, the fuse unit 1 of FIG. 5 is disposed on the first side Z1 with respect to the electrode 230 of the battery cell 210. The fuse unit 1 of FIG. 5 is disposed, for example, such that the fuse 5 and the second conductive member 7 are located above the bus bar 2 in the vehicle vertical direction. The entire fuse unit 1 of FIG. 5 may be located above the electrode 230.

As described above, the fuse unit 1 of the present embodiment has the fuse 5, the first conductive member 6, and the second conductive member 7. The fuse 5 has the first electrode 51, the second electrode 52, and the fusible portion 53 between the first electrode 51 and the second electrode 52. The first conductive member 6 is connected to the first electrode 51, and the second conductive member 7 is connected to the second electrode 52. The first conductive member 6 extends from the first electrode 51 in the first extending direction D1, and the second conductive member 7 extends from the second electrode 52 in the second extending direction D2. The second extending direction D2 is orthogonal to the first extending direction D1. According to the fuse unit 1 of the present embodiment, the degree of freedom in design when the fuse unit 1 is disposed with respect to the object is improved.

The first conductive member 6 of the present embodiment is connectable to the bus bar 2. In this case, the first electrode 51 and the second electrode 52 of the fuse 5 may be arranged in the second extending direction D2. With such a configuration, the size of the fuse unit 1 in the first extending direction D1 can be reduced.

The first conductive member 6 of the present embodiment is connectable to the bus bar 2. In this case, the first electrode 51 and the second electrode 52 of the fuse 5 may be arranged in the first extending direction D1. With such a configuration, the size of the fuse unit 1 in the second extending direction D2 can be reduced.

The fuse unit 1 may have the holding member 8 made of a resin. The holding member 8 has an accommodation space for accommodating the fuse 5, and may be a member integrally formed with the first conductive member 6 and the second conductive member 7. The holding member 8 integrally formed with the two conductive members 6 and 7 can reduce an external force acting on the fuse 5.

The conductive module 100 of the present embodiment has the fuse unit 1, the bus bar 2, and the detection line 31 which can be disposed on the side surface 210a of the battery cell 210 mounted on the vehicle in the vehicle vertical direction. The bus bar 2 is connected to the first conductive member 6 of the fuse unit 1, and is connectable to the electrode 230 on the side surface 210a of the battery cell 210. The detection line 31 is a voltage detection line connected to the second conductive member 7. According to the conductive module 100 of the present embodiment, the degree of freedom in design when the fuse unit 1 is disposed with respect to the object is improved.

In the conductive module 100, the fuse unit 1 may be disposed such that the fuse 5 and the second conductive member 7 are located above the bus bar 2 in the vehicle vertical direction. In this case, even if liquid leakage occurs from the electrode 230 of the battery cell 210, the leaked liquid is less likely to adhere to the fuse 5 and the second conductive member 7.

In the illustrated battery pack 200, the plurality of battery cells 210 are arranged in the first direction X and form the battery module 220. The battery module 220 has the top surface 220a facing upward in the vehicle vertical direction. The routing member 3 including the detection line 31 is routed on the top surface 220a in the first direction X, for example. With such a configuration, even if liquid leakage occurs from the electrode 230 of the battery cell 210, the leaked liquid is less likely to adhere to the routing member 3.

The position of the trunk line 32 routed to the battery module 220 is not limited to the top surface 220a. For example, the trunk line 32 may be routed along the side surface 210a of the battery cell 210. That is, the trunk line 32 and the fuse unit 1 may be disposed on the same surface of the battery cell 210. In this case, the routing member 3 is preferably disposed above the electrode 230 of the battery cell 210 in the vehicle vertical direction.

The position of the fuse unit 1 disposed in the battery module 220 is not limited to the side surface in the third direction Z. For example, the fuse unit 1 may be disposed on the top surface 220a of the battery module 220. In this case, the trunk line 32 and the fuse unit 1 may be disposed on the same surface of the battery cell 210.

The application target of the fuse unit 1 is not limited to the battery module 220. The fuse unit 1 may be applied as a protection circuit to other devices. The target to which the first conductive member 6 is connected is not limited to the bus bar 2. The second connecting portion 62 of the first conductive member 6 may be connected to a routing member such as an electric wire, or may be connected to another conductive member. The target to which the second conductive member 7 is connected is not limited to the electric wire. The second connecting portion 72 of the second conductive member 7 may be connected to a circuit or the like of a flexible printed circuit board, or may be connected to another conductive member.

The contents disclosed in the above embodiments can be appropriately combined and executed.

A fuse unit according to the present embodiment includes a fuse having a first electrode, a second electrode, and a fusible portion between the first electrode and the second electrode, a first conductive member connected to the first electrode, and a second conductive member connected to the second electrode. The first conductive member extends from the first electrode in a first extending direction, and the second conductive member extends from the second electrode in a second extending direction orthogonal to the first extending direction. The fuse unit according to the present embodiment has an advantage of being capable of improving a degree of freedom in design when the fuse unit is disposed with respect to an object.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fuse unit comprising:
a fuse having a first electrode, a second electrode, and a fusible portion between the first electrode and the second electrode;
a first conductive member connected to the first electrode; and
a second conductive member connected to the second electrode,
wherein the first conductive member extends from the first electrode in a first extending direction, and
wherein the second conductive member extends from the second electrode in a second extending direction orthogonal to the first extending direction.

2. The fuse unit according to claim 1,
wherein the first conductive member is connectable to a bus bar, and
wherein the first electrode and the second electrode are arranged in the second extending direction.

3. The fuse unit according to claim 1,
wherein the first conductive member is connectable to a bus bar, and
wherein the first electrode and the second electrode are arranged in the first extending direction.

4. The fuse unit according to claim 1, further comprising a holding member made of a resin which has an accommodation space for accommodating the fuse and is integrally formed with the first conductive member and the second conductive member.

5. A conductive module comprising:
the fuse unit according to claim 1 capable of being disposed on a side surface of a battery cell mounted on a vehicle in a vehicle vertical direction;
a bus bar that is connected to the first conductive member and connectable to an electrode on the side surface of the battery cell; and
a voltage detection line connected to the second conductive member.

6. The conductive module according to claim 5, wherein the fuse unit is disposed such that the fuse and the second conductive member are located above the bus bar in the vehicle vertical direction.

7. The conductive module according to claim 5,
wherein a plurality of the battery cells are arranged in a first direction and form a battery module,
wherein the battery module has a top surface facing upward in the vehicle vertical direction, and
wherein a routing member including the voltage detection line is routed on the top surface in the first direction.

8. The conductive module according to claim 6,
wherein a plurality of the battery cells are arranged in a first direction and form a battery module,
wherein the battery module has a top surface facing upward in the vehicle vertical direction, and
wherein a routing member including the voltage detection line is routed on the top surface in the first direction.
